(19) United States
(12) Patent Application Publication
(10) Pub. No.: US 2007/0028284 A1
(43) Pub. Date: Feb. 1, 2007

(54) Method for browsing information with set top box having tv plaza function

(76) Inventor: Zino Lee, Seoul (KR)

Correspondence Address: Ludomir A Budzyn;Hoffmann & Baron, 6900 Jericho Turnpike, Syosset, NY, 11791, US

(21) Appl. No.: 10/555,241

(22) PCT Filed: Apr. 30, 2004
(86) PCT No.: PCT/KR04/01014

§ 371 Date: Oct. 31, 2005

(30) Foreign Application Priority Data
May 1, 2003 (KR) 10-2003-0027937

(51) Int. Cl. H04N 7/16; G06F 3/00; G06F 13/00; H04N 7/173; H04N 5/445

(52) U.S. Cl. 725/135; 725/37; 725/134; 725/142

(57) ABSTRACT

The present invention relates to a method for browsing an information with a set top box having TV plaza function, comprising the steps of: i) storing a TV plaza information signal, independently of a user's request, to a storage device of the set top box in order to construct a TV plaza within the set top box; ii) in response to user's selection of an item to be interested in, bookmarking a metadata of the selected item in a memory of the set top box; iii) extracting data directed to the bookmarked metadata of the selected item from the TV plaza information stored in the storage device; and iv) delivering the extracted data to user's TV in order to display them on the user's TV.

### TECHNICAL FILED OF THE INVENTION

The present invention relates to method for browsing information with a set top box having TV plaza function.

### BACKGROUND OF THE INVENTION

Interactive televisions have been tested and developed by various satellite broadcasting providers, telephone providers and/or cable television providers. The interactive televisions enable users to actively interact with the televisions beyond simple channel manipulation, simple tone control, simple videotape recoding, etc. For example, the users of the interactive televisions can make an access to videos on demand, payments of bills, banking and shopping, and participate in forums. The interactive televisions are expected to substantially accelerate the information society including the people who are not intimate to a computer such as housewives and the aged. But, there remain some unsolved problems of low transmission rate, low distribution of bi-directional transmission network.

FIG. 1 schematically illustrates the basic structure of one of the conventional set top boxes. As shown in FIG. 1, the conventional set top box comprises a signal input interface 100 which receives a broadcast signal from broadcasting providers, a demultiplexer (DEMUX) 200 which classifies the received broadcast signal, a signal output interface 300 which decodes the received broadcast signal and transmits the decoded broadcast signal to a user's display device, and a microprocessor 400 which generates a command in response to user's control signal.

FIG. 2 schematically illustrates an exemplary embodiment of the processing of a broadcast signal by the conventional set top box shown in FIG. 1, wherein a signal input interface 100 comprises a tuner 101 which receives an encoded broadcast signal and a channel decoder 102 which extracts a user-requested channel from the received broadcast signal under control of a microprocessor 400. The broadcast signal encoded under a suitable compression standard can be one of a video signal, an audio signal, a data signal for data broadcast or a composite signal thereof. The broadcast signal is classified by the action of a DEMUX 200 and then is transmitted to a signal output interface 300.

Relied upon the forms of the broadcast signal, the signal output interface 300 comprises at least one decoder selected from the group consisting of a data decoder 301 which decodes the data signal, a video decoder 302 which decodes the video signal, and an audio decoder 303 which decodes the audio signal. For example, the DEMUX 200 extracts an audio signal from the user-requested channel and then transmits it to the audio decoder 303 which decodes the delivered audio signal and transmits the decoded signal to a user's speaker in an analog form.

Likewise, a video signal is decoded by the video decoder 302 of the signal output interface 300 and is then transmitted to a user's TV. If the user's TV is analog type, the decoded video signal is transmitted to the user's TV in an encoded form by one of various standard video formats, for example, NTSC (National Television Standard Committee), RGB (Red-Green-Blue) and PAL (Phase Alternation by Line). In case that the broadcast signal is a composite signal, for example, of the data signal and the video signal, the data and video signals are separated each other from the composite signal by the action of the DEMUX 200 and is transmitted to the data decoder 301 and the video decoder 302, respectively. If matching of the decoded data and video signals is required, the matching is performed through graphic over lay technology. The matched signal is then transmitted to the user's TV.

In order to satisfy various demands of the users, the set top box may additionally comprise an operating system, operating program, a memory (ROM, RAM) storing the data in use, and a storage device (for example, a hard drive) into which the programs to be recorded are stored.

However, the method for searching items to be interested in is not well established. Even though bi-directional communications are popularly used, the time for accessing to external servers through return path servers would be very longer. Frequent access to the external servers might be an excessive burden to the return path servers.

### SUMMARY OF THE INVENTION

The object of the present invention is to provide a method for browsing items to be searched in a simple and rapid manner, without any access to an external server.

Another object of the present invention is to provide a method for browsing information with a set top box having TV plaza function, comprising the steps of: i) storing a TV plaza information signal, independently of a user's request, to a storage device of the set top box in order to construct a TV plaza within the set top box; ii) in response to user's selection of an item to be interested in, bookmarking a metadata of the selected item in a memory of the set top box; iii) extracting data directed to the bookmarked metadata of the selected item from the TV plaza information stored in the storage device; and iv) delivering the extracted data to user's TV in order to display them on the user's TV.

The other object of the present invention is to provide a method for provide a method for browsing information with a set top box having TV plaza function, wherein the TV plaza information comprises a first identification data region from which the transmitted information is identified as an TV plaza information, a second identification data region from which a TV plaza subscriber to whom the TV plaza information belongs is identified, a data region into which a TV plaza information to be informed from a TV plaza subscriber to a user is stored, and a metadata region into which a metadata is included, and the step iii) is carried out by comparing the bookmarked metadata of the selected item with the metadata of the TV plaza information.

### BRIEF DESCRIPTION OF THE DRAWINGS

FIG. 1 is a schematic block diagram illustrating the basic structure of the conventional set top box, and the flow of a broadcast signal.

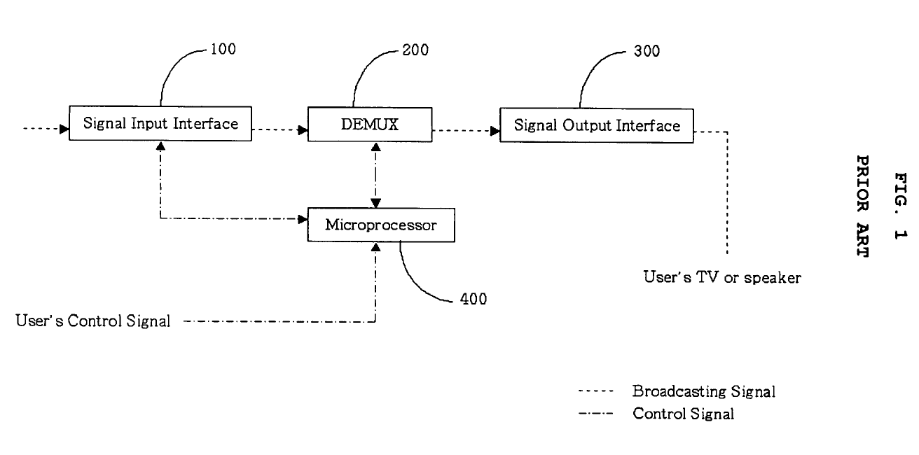

FIG. 2 is a schematic block diagram illustrating a specific exemplary embodiment of the conventional set top box shown in FIG. 1, and the flow of a broadcast signal.

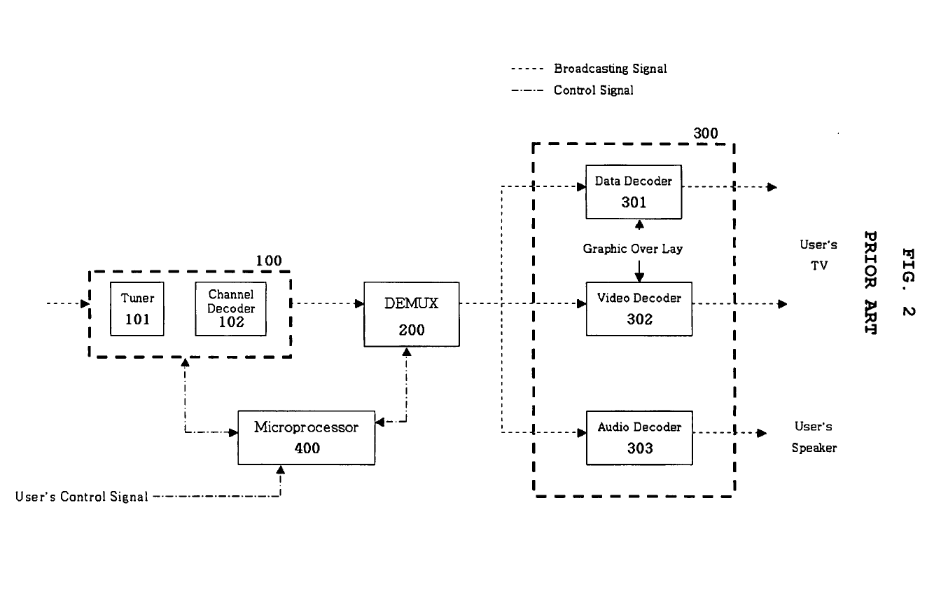

FIG. 3 is a schematic block diagram illustrating the method of the present invention.

FIG. 4 is a constitutional diagram showing a preferred embodiment of a TV plaza information signal which is adequate for the method of the present invention.

FIG. 5 is a block diagram exemplarily illustrating the method of the present invention.

FIG. 6 is a diagram showing a preferred embodiment of a user interface displayed on user's TV.

### DETAILED DESCRIPTION OF THE INVENTION

As used herein, the phrase “TV plaza” (television plaza) refers to a plaza formed within a set top box, wherein the plaza is formed by storing information data supplied from various information providers other than a TV user (or viewer) into a storage device of the set top box independently of the TV user (or viewer), and the user searches and displays the information data previously stored within the set top box onto the user's TV. That is, TV plaza refers to a plaza of the information data stored independently of the user's request into a storage device of the set top box and the user can browse or navigate the user-independently stored information and displays the user-requested information.

The phrase “TV plaza information”, as used herein, refers to information supplied for the construction of TV plaza. The storage and the correction of the TV plaza information are independent of a user's request or demand, while the navigation and the display of the information are dependent upon the user's request. Such TV plaza information may be life information including advertisement information (for example goods information and company information), education information, stock information and weather information. Further, the phrase “a TV plaza information signal” refers to a signal produced from suitable digital encoding of TV plaza information such that a set top box can receive the signal. The TV plaza information signal is characterized in that the information signal is independent of the ordinary broadcast signal and is stored independently of the user's request into a storage device such as hard disk assigned to store the information signal, thereby constructing TV plaza within the set top box of the user.

The phrase “a broadcast signal”, as used herein, refers to a signal in which a user can determine both the storage of the broadcast signal and the display thereof. Such a broadcast signal includes, but is not limited to, ordinary signals supplied by television broadcasting provider such as KBS, MBC, SBS, CNN and NHK, satellite broadcasting providers and CATV broadcasting providers.

While providers for the TV plaza information signal can be different from those for the broadcast signal, preferably the TV plaza information signal and the broadcast signal are provided by the same providers. But, it should be understood that TV plaza information signal and the broadcast signal are provided in a separated form. The phrase “a separated form” means that the TV plaza information signal has different identification information from that of the broadcast signal.

The phrase “a TV plaza operator”, as used herein, refers to a person who operates and manages TV plaza as a whole. Further, “a TV plaza subscriber” refers to a person who provides TV plaza information under the agreement with the TV plaza operator. As a TV plaza subscriber, the persons who intend to advertise goods, to inform companies and/or services can be mentioned.

In the following, the present invention will be more fully illustrated referring to the attached drawings.

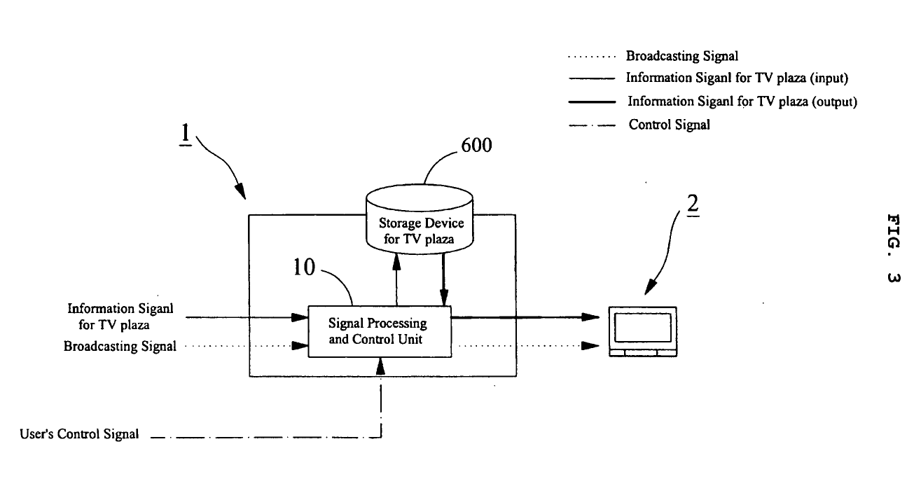

FIG. 3 is a schematic block diagram illustrating the method of the present invention. A TV plaza information signal transmitted together with a broadcast signal is processed by a signal processing and control unit 10 of a set top box 1, and is stored, independently of a user's request, in a storage device 600 of the set top box 1 in order to construct a TV plaza. The broadcast signal is also processed by the signal processing and control unit 10 and a user-requested channel signal is displayed on user's TV 2. When an item about which a user want to have more detailed information is found in the displayed program, a user selects the item by manipulation of a control device (for example, a remote controller or a wireless keyboard). A metadata corresponding to the selected item is bookmarked in a memory (not shown) of the signal processing and control unit 10. In response to the user's request, the signal processing and control unit 10 browses and extracts data directed to the metadata of the item to be interested in from a TV plaza constructed in the storage device 600. The extracted TV plaza information is transferred and displayed on the user's TV 2.

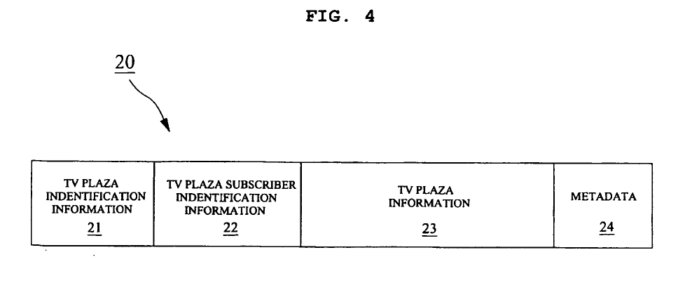

FIG. 4 is a constitutional diagram showing a preferred embodiment of a TV plaza information signal which is adequate for the method of the present invention. The TV plaza information signal 20 comprises a TV plaza information identification data region 21, a TV plaza subscriber identification data region 22, a TV plaza information data region 23 and a metadata region 24. The TV plaza information identification data region 21 includes the information from which the transmitted information is identified as a TV plaza information. The signal processing and control unit 10 examines the TV plaza information identification data region 21 in order to confirm whether the received data is the TV plaza information or not. If the received data is proven to be a TV plaza information, it delivers the received data to a storage device 600 independently of the user's request. The TV plaza subscriber identification data region 22 includes the information from which a TV plaza subscriber is identified. The signal processing and control unit 10 examines the TV plaza subscriber identification data region 22 in order to confirm to whom the TV plaza information belongs, and then stores the received data in a corresponding storage region of the storage device 600. The TV plaza subscriber identification data region 22 allows subscriber-dependent storage and management of the TV plaza information. The TV plaza information data region 23 includes the information of which the TV plaza subscriber informs the user. In response to the user's request for more detailed information, the TV plaza information data region 23 is displayed on the user's TV 2. The metadata region 24 includes a metadata, which allows efficient management of the TV plaza information. For example, when advertising information is included in the TV plaza information data region 23, the name of the manufacturer, the name of goods and brief description thereto can be included in the metadata region 24.

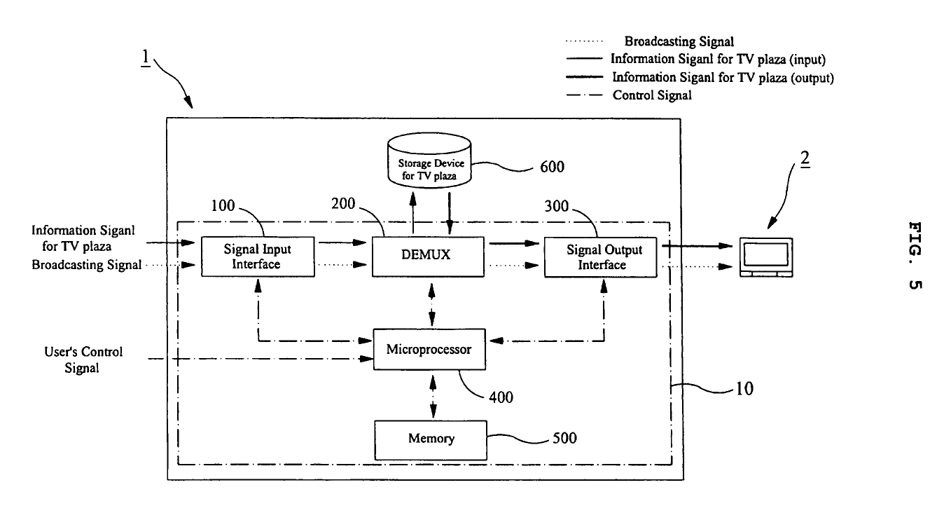

FIG. 5 is a block diagram exemplarily illustrating the method of the present invention. The signal processing and control unit 10 of a set top box 1 comprises at least a signal input interface 100, a demultiplexer (DEMUX) 200, a signal output interface 300, a microprocessor 400 and a memory 500. The signal input interface 100 receives the broadcast signal and the TV plaza information signal, and the DEMUX 200 classifies the received signals and separates them into an audio signal, a video signal and a data signal for data broadcasting. The signal output interface 300 coupled to a user's TV 2, decodes and delivers the signals to the user's TV 2. The microprocessor 400 controls the system, and the memory 500 stores operating systems, applications and data in use. The memory 500 is classified as a ROM (read only memory) which stores the operating systems and the applications and a RAM (random access memory) which stores the operating systems and the applications, and the data in use. As a RAM, a non-volatile flash memory can be used. The storage device 600 of the set top box 1 includes regions assigned to store the TV plaza information.

The TV plaza information signal and the broadcast signal, which are preferably digitally compressed by one of various compression standards (for example, MPEG standard), are firstly transmitted to the signal input interface 100 of the signal processing and control unit 10. Of the received signals, the TV plaza information signal is separated from the broadcast signal by the DEMUX 200 and then, is stored independently of the user's control signal into a storage device 600 to construct a TV plaza within the set top box 1 of the user. When a user's request for the information is received, the TV plaza information stored in the storage device 600 is transmitted to the signal output interface 300 via the DEMUX 200 under control of the microprocessor 400, and there, the TV plaza information is decoded and displayed on the user's TV 2. In a meanwhile, when the TV plaza information signal and/or the broadcast signal is a composite signal having a mixed form selected from a video signal, an audio signal and a data signal for data broadcast, the composite signal is separated into one another by action of the DEMUX 200 and then is transmitted to the corresponding decoder, and the decoded signal is delivered to the user's TV 2. The broadcast signal of the received signals is processed in a conventional manner. That is, the broadcast signal is transmitted to the signal output interface 300 through the DEMUX 200 under control of the microprocessor 400, and there, decoding of the broadcast signal is performed. The decoded broadcast signal is then transmitted and displayed on the user's TV 2.

In viewing the displayed program, the user may find an item about which more detailed information is required. When the item to be searched is selected by the user, the metadata corresponding to the selected item is bookmarked in response to the user's request, under the control of the microprocessor 400 in the memory 500, more specifically in the RAM. Thereafter, the microprocessor 400 browse the TV plaza information stored in the storage device 600 and then extracts the TV plaza information directed to the bookmarked metadata of the item to be interested in. Decision on the relevancy is carried out by comparing the bookmarked metadata of the selected item with the metadata of the TV plaza information. The extracted TV plaza information is transferred and displayed on the user's TV 2 through the DEMUX 200 and the signal output interface 300. Herein, it is preferable to display the metadata of the extracted information at first. The user may display the whole information to be interested in by browsing and selecting the displayed metadata of the extracted TV plaza information.

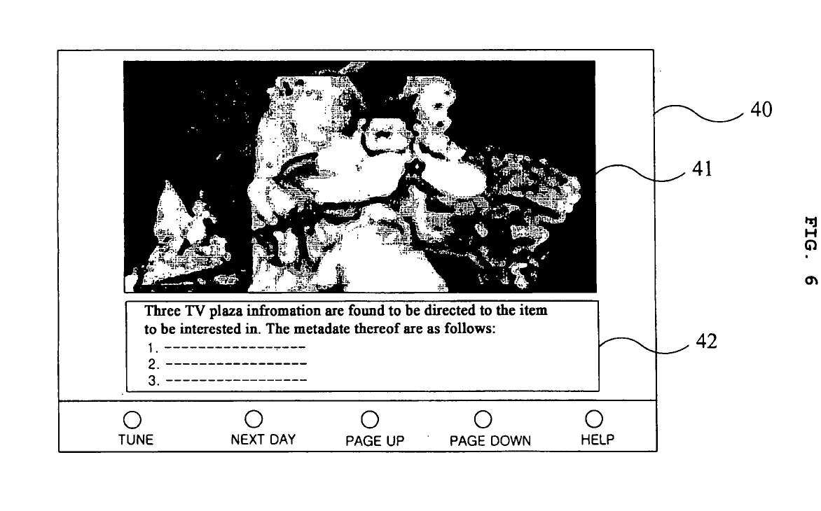

FIG. 6 shows a preferred embodiment of a user interface displayed on the user's TV. As shown in FIG. 6, the user interface 40 comprises a screen display window 41 which displays the program to be view, and a result display window 42 which displays the search results, wherein the user selects the metadata to be browsed using a control device such as remote controller, and detailed contents of the information is displayed, for example, on the screen display window 41 or on an additional pop-up window.

### INDUSTRIAL APPLICABILITY

The method for browsing information with the set top box having TV plaza function according to the present invention enables a simple and rapid access to the information to be interested in. That is, even though the information can be obtained from bi-directional communication, the method utilizes the subscriber-dependent TV plaza information constructed within the set top box. For this reason, the method makes it possible to save the time required for the access to external severs via return path servers and to secure the information in a simple and rapid manner. The method avoids possible excessive burdens loaded to the return path servers resulted from acquisition of the information through bi-directional communication.

1. A method for browsing information with a set top box having TV plaza function, comprising the steps of: i) storing a TV plaza information signal, independently of a user's request, to a storage device of the set top box in order to construct a TV plaza within the set top box; ii) in response to user's selection of an item to be interested in, bookmarking a metadata of the selected item in a memory of the set top box; iii) extracting data directed to the bookmarked metadata of the selected item from the TV plaza information stored in the storage device; and iv) delivering the extracted data to user's TV in order to display them on the user's TV.

2. The method as set forth in claim 1, wherein the TV plaza information comprises a first identification data region from which the transmitted information is identified as an TV plaza information, a second identification data region from which a TV plaza subscriber to whom the TV plaza information belongs is identified, a data region into which a TV plaza information to be informed from a TV plaza subscriber to a user is stored, and a metadata region into which a metadata is included, and the step iii) is carried out by comparing the bookmarked metadata of the selected item with the metadata of the TV plaza information.

3. The method as set forth in claim 1, wherein the step iv) is carried out by displaying the metadata of the extracted TV plaza information at first, and then displaying detailed contents of the TV plaza information directed to the user-selected metadata.
